(19) United States
(12) Patent Application Publication
(10) Pub. No.: US 2015/0180260 A1
(43) Pub. Date: Jun. 25, 2015

(54) POWER SUPPLY WITH CURRENT SHARING CONTROL AND THE BATTERY MODULE

(71) Applicant: METAL INDUSTRIES RESEARCH & DEVELOPMENT CENTRE, Kaohsiung City (TW)

(72) Inventors: CHUN-YING JUAN, KAOHSIUNG CITY (TW); CHIA-YAO CHANG, KAOHSIUNG CITY (TW)

(73) Assignee: METAL INDUSTRIES RESEARCH & DEVELOPMENT CENTRE, Kaohsiung City (TW)

(21) Appl. No.: 14/136,207

(22) Filed: Dec. 20, 2013

(51) Int. Cl. H02J 7/00

(52) U.S. Cl. CPC H02J 7/0072; H02J 7/0063; H02J 7/0029; H02J 2007/0067

(57) ABSTRACT

A power supply with current sharing control and its battery module are disclosed. Wherein, the power supply comprises a main controller and a plurality of battery modules in a parallel connection. The battery modules output a plurality of current status signals according to current quantities of output currents output by their respective battery units. The main controller outputs a plurality of current sharing control instructions according to the current status signals, thereby commanding the battery modules to adjust the output current quantities of the output currents. Therefore, the battery modules respectively adjust the output currents of the battery units by themselves to prevent the battery units from being damaged due to a forced discharge and to equalize the current quantities of the output currents.

### BACKGROUND OF THE INVENTION

1. Field of the Invention

The present invention relates to a power supply and its battery module, particular to a power supply with current sharing control and the battery modules of using the same.

2. Description of the Related Art

Currently, lots of electronic products or transportation systems use the secondary battery as the power supply. Wherein, the circumstance in which people rely on cars, motorcycles, etc. extremely brings about a large quantity and a growing growth of such transportation year by year, so the demand of fuel is quite large. Further, the problems, such as the high price of the fuel, a gradual consumption of oil resources on the earth, over high oil consumption caused by the incomplete combustion of the fuel and the discharge of waste gas, still cannot be solved effectively. Therefore, lots of firms use other substitutes and develop electric vehicles accordingly.

To cooperate with gradual enhanced electronic products or transportation systems and meet practical demands of batteries with high output electric quantity, the known technique of the battery industry is executed by connecting multiple batteries in series or in parallel, thereby constituting an integrated battery with a high output quantity as a device for supplying power.

However, the output currents of the batteries inside such power supply constructed by these series-connected or parallel-connected batteries are usually affected by a system end (or a loading end), namely these batteries would be discharged forcedly when the system end needs large currents. This circumstance damages the batteries easily. Further, the different output currents of these batteries means the time of consuming energy of these batteries are not the same, so part of the batteries may still have residual energy stored and keep discharging but part of them may consume all of the stored energy already. Under this situation, such batteries are usually over discharged, and the supplying efficiency of the power supply is decreased. Therefore, the issue how to manage the output currents of these batteries is quite important in this technical field.

Therefore, the present invention provides a power supply with current sharing control and its battery modules to improve the above problems.

### SUMMARY OF THE INVENTION

One object of the present invention is to provide a power supply with current sharing control and its battery modules. The present invention applies a main controller to output a plurality of current sharing control instructions to a plurality of battery modules according to current status signals output by the battery modules, thereby controlling current quantities of output currents of these battery modules to increase the supplying efficiency of the power supply.

One object of the present invention is to provide a power supply with current sharing control and its battery modules. The present invention detects and determines if the current quantity of the output current of each battery module is higher or lower than a threshold value, whereby a main controller commands the battery modules to adjust the output current quantities of the output currents according to the determined result in order to prevent the batteries modules from be damaged due to the forced discharge.

One object of the present invention is to provide a power supply with current sharing control and its battery modules. The present invention detects and determines if the current quantity of the output current of each battery module is higher or lower than a threshold value, whereby a main controller commands the battery modules to adjust the output current quantities of the output currents according to the determined result in order to equalize the current quantities of the output currents.

To obtain the stated objectives and purposes, the power supply with current sharing control in accordance with the present invention comprises a plurality of battery modules which are connected in parallel and output a plurality of output currents respectively. The battery modules output a plurality of current status signals according to current quantities of the output currents respectively. The present invention also comprises a main controller coupled to the battery modules and outputting a plurality of current sharing control instructions to the battery modules respectively according to the current status signals. Wherein, the battery modules adjust the output current quantities of the output currents according to the current sharing control instructions respectively.

The present invention further discloses a battery module of a power supply with current sharing control comprising a battery unit for providing an output current, a current detecting unit coupled to the battery unit and detecting a current quantity of the output current for outputting a detecting signal, a control unit coupled to the current detecting unit and outputting a current status signal to a main controller according to the detecting signal, wherein the main controller sends a current sharing control instruction back to the control unit according to the current status signal in order that the control unit outputs an on-state control signal, and a first switch unit coupled to the battery unit and the control unit, wherein a conduction degree of the first switch unit is determined according to the on-state control signal, and the current quantity of the output current which flows through the first switch unit is decided by the conduction degree.

The present invention further discloses a power supplying method for current sharing control comprising steps of connecting a plurality of battery modules in parallel and outputting a plurality of output currents respectively, outputting a plurality of current status signals according to current quantities of the output currents respectively, coupling a main controller to the battery modules and outputting a plurality of current sharing control instructions to the battery modules respectively according to the current status signals, and adjusting the output current quantities of the output currents according to the current sharing control instructions respectively.

### BRIEF DESCRIPTION OF THE DRAWINGS

FIG. 1 is a block diagram of the circuit of the power supply with current sharing control of the present invention;

FIG. 2 is a schematic view showing the power supply with current sharing control of a preferred embodiment of the present invention;

FIG. 3 is a block diagram of the circuit of the battery module of a first preferred embodiment of the present invention;

FIG. 4 is an oscillogram demonstrating a linear region of the power transistor;

FIG. 5 is a block diagram of the circuit of the battery module of a second preferred embodiment of the present invention;

FIG. 6 is a block diagram of the circuit of the battery module of a third preferred embodiment of the present invention;

FIG. 7 is a block diagram of the circuit of the battery module of a fourth preferred embodiment of the present invention; and

FIG. 8 is a block diagram of the circuit of the control unit of a preferred embodiment of the present invention.

### DETAILED DESCRIPTION OF THE PREFERRED EMBODIMENTS

Some terms are used in the description and subject claims to name the specific elements. It is noted that these terms should be understood by those of ordinary skilled in the art although some hardware manufacturers may adopt different names to express the same element. These elements are defined and specified according to differences of functions of elements rather than differences of names in the subject description and claims. The term “comprising” in the description and claims is an open-ended term, which is inclusive and does not restrict the scope. Further, the term “couple to” includes any direct or indirect means for electrically connecting. Therefore, a phrase “the first device is coupled to the second device” should be understood that the first device can be directly and electrically connected to the second device or be indirectly and electrically connected to the second device by other apparatus or connective ways.

The features and advantages of the present invention are more apparent to the Examiner upon reading preferred embodiments and detail descriptions as follows.

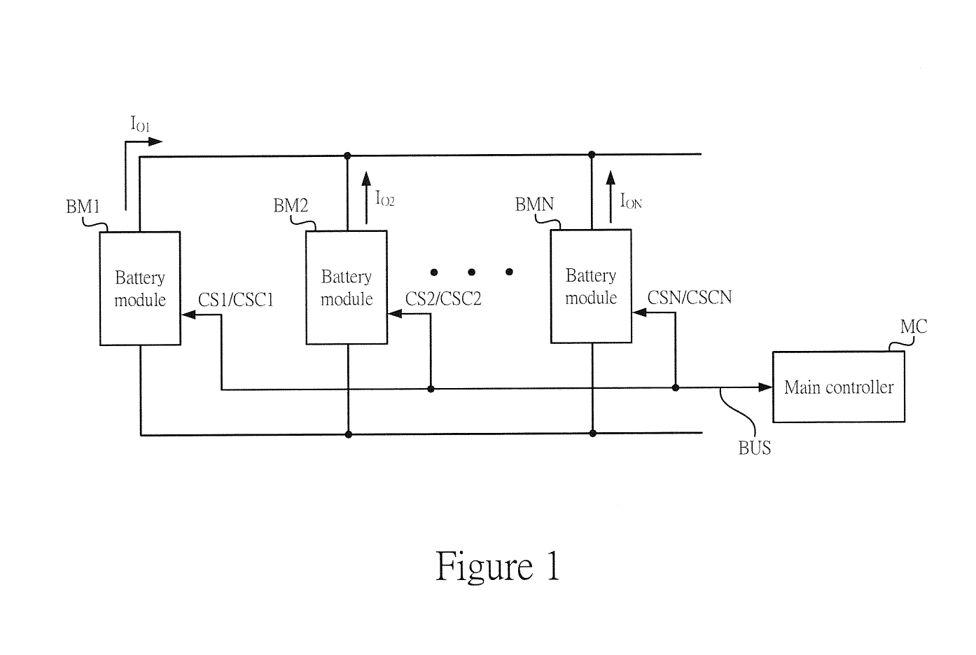

Referring to FIG. 1, a block diagram of a circuit of the power supply with current sharing control of the present invention is shown. As shown in the figure, the power supply of the present invention comprises a plurality of battery modules BM1, BM2 to BMN and a main controller MC. The battery modules BM1, BM2 to BMN are connected in parallel and output a plurality of output currents I_{O1}, I_{O2} to I_{ON} respectively. The battery modules BM1, BM2 to BMN output a plurality of current status signals CS1, CS2 to CSN according to current quantities of the output currents I_{O1}, I_{O2} to I_{ON} respectively. The main controller MC is coupled to the battery modules BM1, BM2 to BMN. For example, the main controller MC is coupled to the battery module BM1, BM2 to BMN via a common single busway and output a plurality of current sharing control instructions CSC1, CSC2 to CSCN to the battery modules BM1, BM2 to BMN respectively according to the current status signals CS1, CS2 and CSN, which allows the battery modules BM1, BM2 to BMN to adjust the output current quantities of the output currents I_{O1}, I_{O2} to I_{ON} according to the current sharing control instructions CSC1, CSC2 to CSCN respectively. Preferably, in this preferred embodiment, the power supply further comprises a busway BUS, such as RS-485 BUS, for coupling the main controller MC to the battery modules BM1, BM2 to BMN and transmitting the current status signals CS1, CS2 to CSN and the current sharing control instructions CSC1, CSC2 to CSCN.

In use of the power supply with current sharing control of the present invention, there is disclosed a power supplying method for current sharing control, which comprises steps of connecting the battery modules BM1, BM2 to BMN in parallel to allow the battery modules BM1, BM2 to BMN to output the output currents I_{O1}, I_{O2} to I_{ON}, then outputting the current status signals CS1, CS2 to CSN by the battery modules BM1, BM2 to BMN according to output current quantities of the output currents I_{O1}, I_{O2} to I_{ON} respectively, thence coupling the main controller MC to the battery modules BM1, BM2 to BMN to allow the main controller MC to output the current sharing control instructions CSC1, CSC2 to CSCN to the battery modules BM1, BM2 to BMN respectively according to the current status signals CS1, CS2 to CSN, and finally allowing the battery modules BM1, BM2 to BMN to adjust the output current quantities of the output currents I_{O1}, I_{O2} and I_{ON} according to the current sharing control instructions CSC1, CSC2 and CSN.

Wherein, the battery modules BM1, BM2 to BMN respectively detect the output current quantities of the output currents I_{O1} I_{O2} or I_{ON} and determine if the current quantity of the output current I_{O1}, I_{O2} or I_{ON} is higher or lower than a threshold value, thereby outputting the current status signal CS1, CS2 or CSN correspondingly to the main controller 20. In other words, the battery module BM1 detects the current quantity of the output current I_{O1}, determines if the current quantity of the output current I_{O1} is higher or lower than the threshold value and thence output the current status signal CS1 correspondingly. The battery module BM2 detects the current quantity of the output current I_{O2}, determines if the current quantity of the output current I_{O2} is higher or lower than the threshold value and thence output the current status signal CS2 correspondingly. The rest of the battery modules are deduced likewise.

The main controller MC obtains the comparison results showing whether the respective current quantities of the output currents I_{O1}, I_{O2} to I_{ON} output by the battery modules BM1, BM2 to BMN are higher or lower than the threshold value according to the current status signals CS1, CS2 to CSN and then sends the current sharing control instructions CSC1, CSC2 to CSCN back to the battery modules BM1, BM2 to BMN respectively, namely the current sharing control instruction CSC1 is sent back to the battery module BM1, the current sharing control instruction CSC2 is sent back to the battery module BM2, . . . , and the current sharing control instruction CSCN is sent back to the battery module BMN, thereby commanding the battery modules BM1, BM2 to BMN to self-adjust the current quantities of the output currents I_{O1}, I_{O2} to I_{ON}.

For example, in case a threshold value is set by 1 A (Ampere) and the power supply provides the conditions that the battery module BM1 outputs an output current I_{O1} of 1.1 A and the battery module BM2 outputs an output current I_{O2} of 0.9 A, the battery module BM1 detects that the output current I_{O1} is 1.1 A, determines it is higher than the threshold value and thence outputs a corresponding current status signal CS1 over the threshold value to the main controller MC. The main controller MC then outputs a current sharing control instruction CSC1 according to the current status signal CS1 to command the battery module BM1 to decrease the current quantity of the output current I_{O1} until the current quantity of the output current I_{O1} is equal to the threshold value. In contrast, the battery module BM2 detects that the output current I_{O2} is 0.9 A, determines it is lower than the threshold value and outputs a corresponding current status signal CS2 lower than the threshold value to the main controller MC. The main controller MC then outputs a current sharing control instruction CSC2 according to the current status signal CS2 to command the battery module BM2 to increase the current quantity of the output current I_{O2} until the current quantity of the output current I_{O2} is equal to the threshold value.

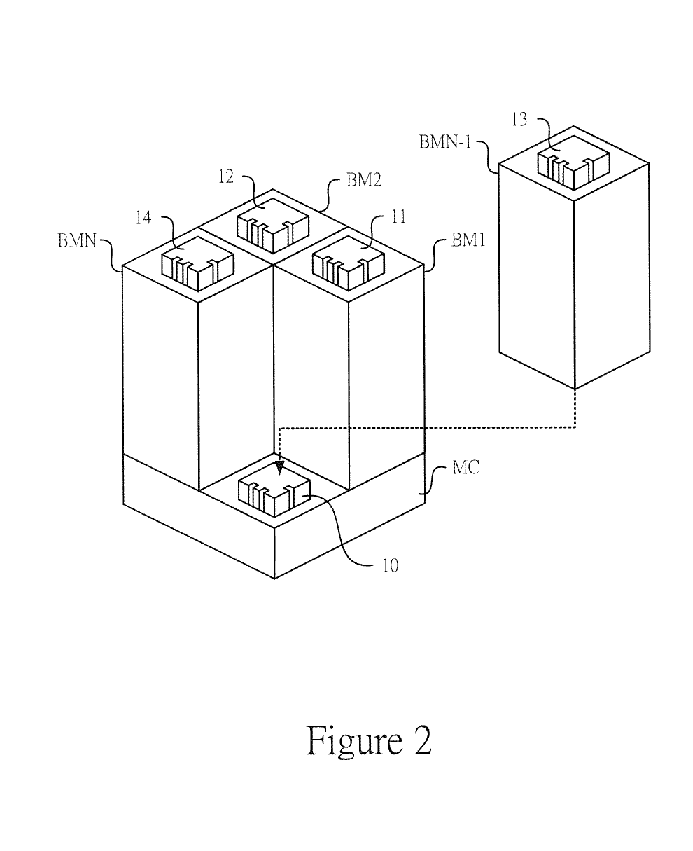

Also referring to FIG. 2, a schematic view showing the power supply with current sharing control of a preferred embodiment of the present invention is shown. As shown in the figure, this preferred embodiment sets the main controller MC as a base which comprises a plurality of joints 10 for electrically connecting to the battery modules BM1, BM2 to BMN-1 and BMN. The battery modules BM1, BM2 to BMN-1 and BMN connected to the joints 10 of the main controller MC are connected in parallel. A plurality of joints 11, 12, 13 and 14 are also disposed on respective tops of the battery modules BM1, BM2 to BMN-1 and BMN for electrically connecting to a system end (or a loading end) and outputting the output currents I_{O1}, I_{O2} to I_{ON} or for connecting more battery modules in series.

Wherein, the main controller MC of this preferred embodiment has four joints 10, three of which (not shown in the figure) are connected to the respective bottoms of the battery modules BM1, BM2 and BMN. It should be noted that this embodiment only shows a preferred embodiment and cannot restrict the scope of the present invention accordingly.

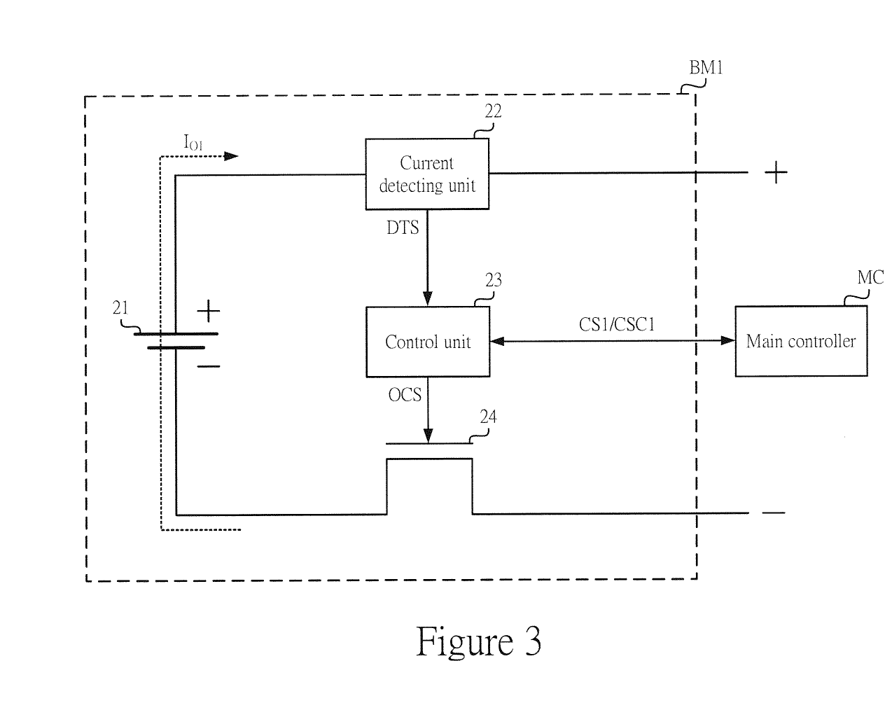

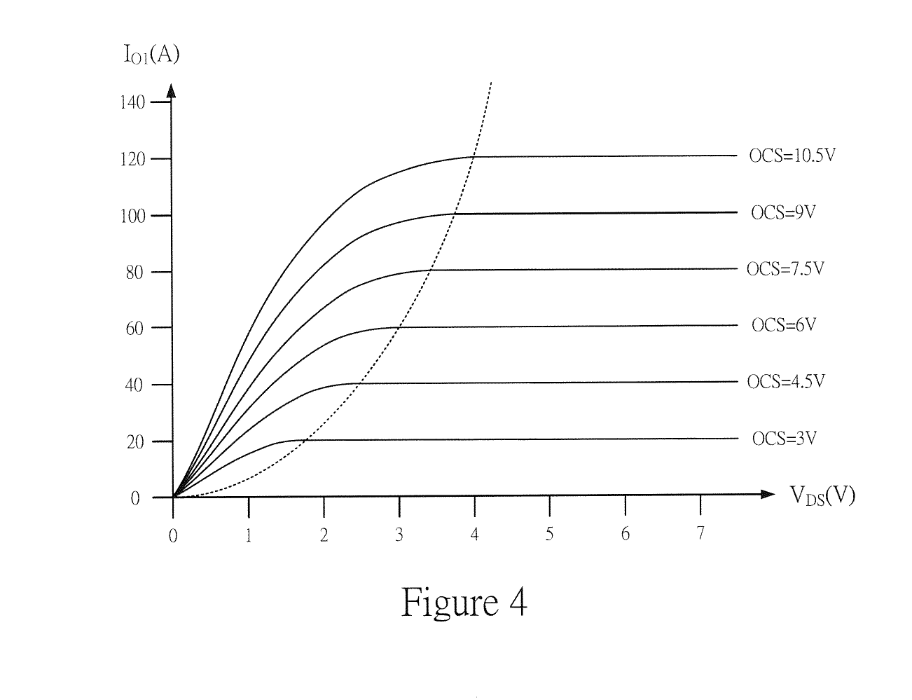

Also referring to FIG. 3, a block diagram of the circuit of the battery module of a first preferred embodiment of the present invention is shown. The circuit structures of the battery modules BM1, BM2 to BMN in FIG. 1 are the same, so this embodiment only describes the battery module BM1 as an example. As shown in the figure, the battery module BM1 includes a battery unit 21, a current detecting unit 22, a control unit 23 and a switch unit 24. The battery unit 21 is used for providing an output current I_{O1}. The current detecting unit 22 is coupled to the battery unit 21 and detects the current quantity of the output current I_{O1} to output a detecting signal DTS. The control unit 23 is coupled to the current detecting unit 22, which determines if the current quantity of the output current I_{O1} is higher or lower than a threshold value according to the detecting signal DTS and then outputs a current status signal CS1 to the main controller MC, whereby the main controller MC sends a current sharing control instruction CSC1 back to the control unit 23, and then the control unit 23 outputs an on-state control signal OCS to the switch unit 24 according to the current sharing control instruction CSC1. The switch unit 24 is coupled to the battery unit 21 and the control unit 23. A conduction degree of the switch unit 24 is determined according to the on-state control signal OCS, and the current quantity of the output current I_{O1} which flows through the switch unit 24 is decided by the conduction degree of the switch unit 24.

Wherein, the battery unit 21 can be any rechargeable battery, such as lead-acid storage battery, nickel-cadmium battery, nickel-metal hydride battery or lithium-ion battery. The switch unit 24 can be a power transistor and can be an N-type transistor or a P-type transistor. The output current I_{O1} is flowing through a drain electrode and a source electrode of the switch unit 24. The coupling relationship between the drain electrode and the source electrode depends on the type of the transistor. A gate electrode of the switch unit 24 is coupled to the control unit 23 for receiving the on-state control signal OCS and operating in a linear region according to the on-state control signal OCS, as depicted in FIG. 4 showing the oscillogram of the linear region of the transistor wherein V_{DS} represents the potential difference between the drain electrode and the source electrode, thereby controlling the conduction degree between the drain electrode and the source electrode of the switch unit 24.

For example, when the control unit 23 determines that the current quantity of the output current I_{O1} is higher than the threshold value, the main controller MC sends the current sharing control instruction CSC1 back to the control unit 23 according to the current status signal CS1 of the control unit 23, whereby the control unit 23 decreases the level of the output on-state control signal OCS in order to decrease the conduction degree of the switch unit 24 for reducing the current quantity of the output current I_{O1} to the threshold value. When the control unit 23 determines that the current quantity of the output current I_{O1} is lower than the threshold value, the main controller MC sends the current sharing control instruction CSC1 back to the control unit 23 according to the current status signal CS1 of the control unit 23, whereby the control unit 23 increases the level of the output on-state control signal OCS in order to add the conduction degree of the switch unit 24 for raising the current quantity of the output current I_{O1} to the threshold value.

As noted above, when the present invention comprises a plurality of battery modules BM1, BM2 to BMN (see FIG. 1), the output current I_{O1}, I_{O2} to I_{ON} of the battery modules BM1, BM2 to BMN can be adjusted to the threshold value, whereby the current quantities of the output currents I_{O1}, I_{O2} to I_{ON} of the battery modules BM1, BM2 to BMN are the same to obtain the current sharing effect.

Furthermore, the main controller MC obtains the difference between the output current I_{O1} and the threshold value according to the current status signal CS1, then determines the current sharing control instruction CSC1 to be output, and thence decides whether to increase or decrease the conduction degree of the switch unit 24. Namely, the higher the current quantity of the output current I_{O1} exceeds the threshold value, the lower the level of the on-state control signal OCS decreased by the main controller MC gets to reduce the conduction degree of the switch unit 24 to a smaller state, whereby the current quantity of the output current I_{O1} can be more decreased. The more the current quantity of the output current I_{O1} is lower than the threshold value, the higher the level of the on-state control signal OCS raised by the main controller MC is obtained to raise the conduction degree of the switch unit 24 to a higher state, whereby the current quantity of the output current I_{O1} can be more increased. In addition, this embodiment mainly uses the control unit 23 to determine whether the current quantity of the output current I_{O1} is higher or lower than the threshold value, which cannot be deemed as a restriction on the present invention. The present invention can also use the main controller MC to determine if the current quantity of the output current I_{O1} is higher or lower than the threshold value.

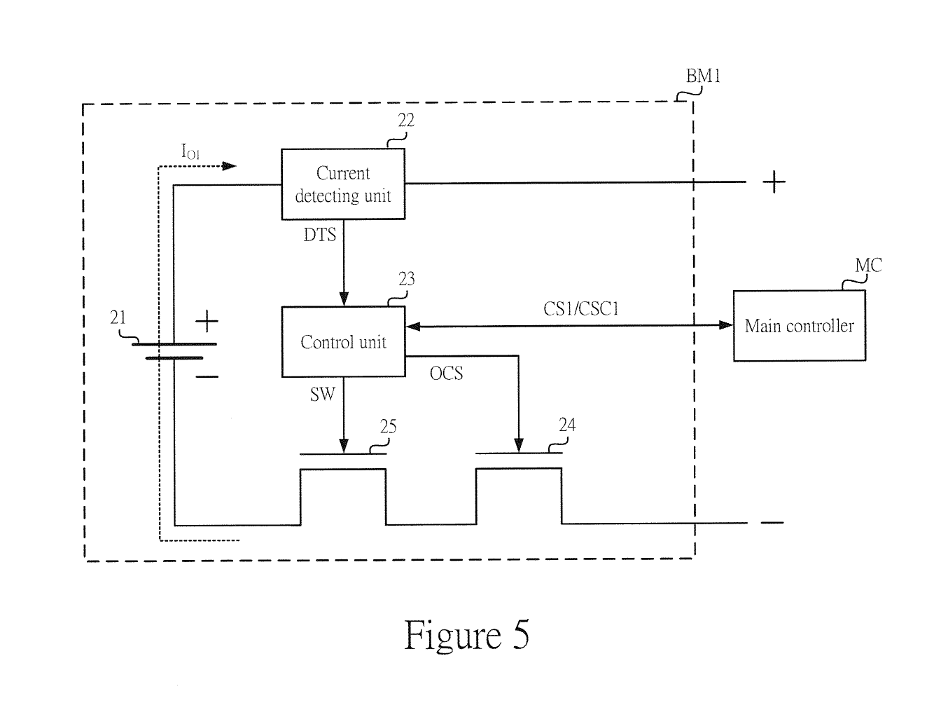

Referring to FIG. 5, a block diagram of the circuit of the battery module of a second preferred embodiment of the present invention is shown. This embodiment, different from the previous embodiment, is characterized in that a switch unit 25 is further disposed. The same concatenation of other correlated elements as that of the previous embodiment is herein omitted.

As shown in the figure, the switch unit 25 is coupled to the battery unit 21 and the control unit 23 and is controlled by a switching signal SW output by the control unit 23, thereby conducting or cutting off the output current I_{O1}. Accordingly, the discharge of the battery unit 21 conducts the output current I_{O1} outputting to the system end, and the charge of the battery unit 21 cuts off the output current I_{O1} outputting to the system end.

Wherein, the switch unit 25 can be a power transistor and can be an N-type transistor or a P-type transistor. The output current I_{O1} is flowing through a drain electrode and a source electrode of the switch unit 25. The coupling relationship between the drain electrode and the source electrode depends on the type of the transistor. A gate electrode of the switch unit 25 is coupled to the control unit 23 for receiving a switching signal SW, thereby executing the conduction or cut-off according to the switching signal SW.

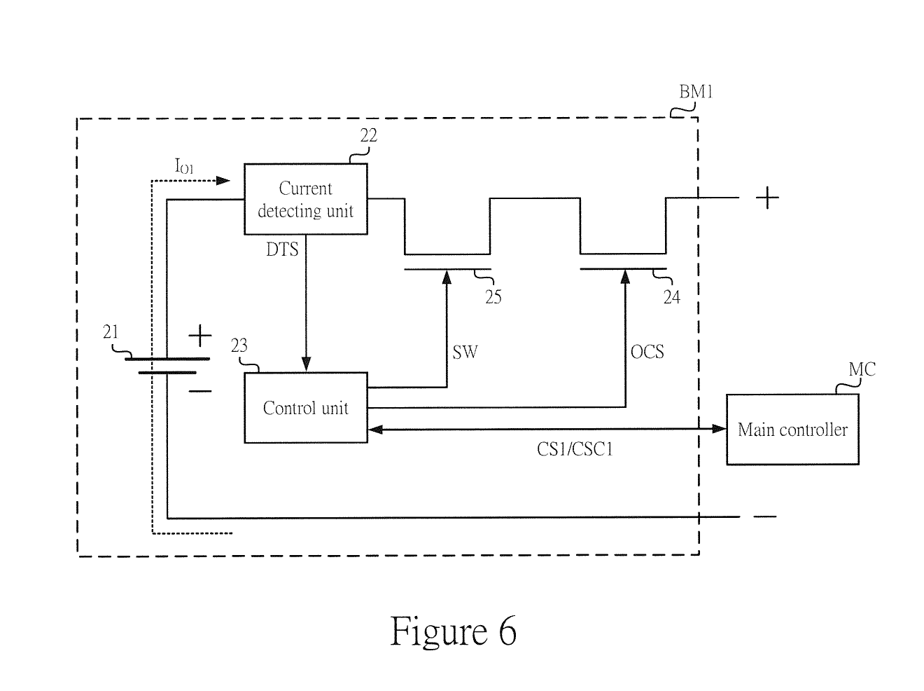

Furthermore, the switch units 24, 25 as illustrated in this embodiment are coupled to the cathode of the battery unit 21, which cannot be deemed as a restriction on the present invention. Alternatively, FIG. 6 shows a block diagram of the circuit of the battery module of a third preferred embodiment of the present invention, in which the switch unit 24 and/or 25 can also be coupled to the anode of the battery unit 21. It is enough to have the switch unit 24 and/or 25 coupled to the battery unit 21 for conducting or cutting off the output current I_{O1}.

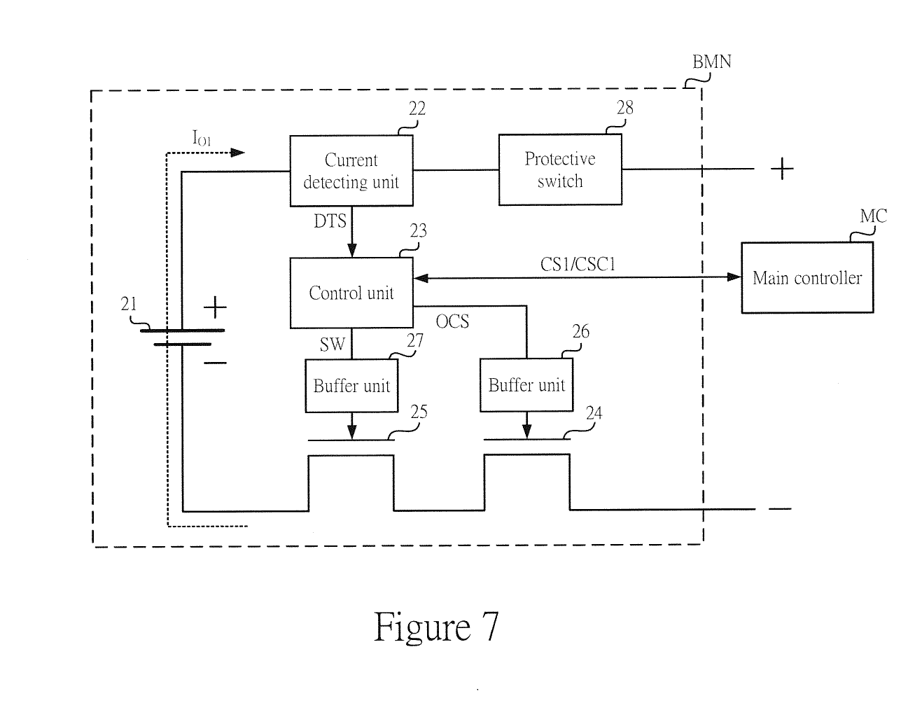

Referring to FIG. 7, a block diagram of the circuit of the battery module of a fourth preferred embodiment of the present invention is shown. This embodiment, different from the previous embodiment, is characterized in that a plurality of buffer units 26, 27 and a protective switch 28 can be further disposed. The same concatenation of other correlated elements as that of the previous embodiment is herein omitted.

As shown in the figure, the buffer unit 26 is coupled between the control unit 23 and the switch unit 24 for buffering the on-state control signal OCS. The buffer unit 27 is coupled between the control unit 23 and the switch unit 25 for buffering the switching signal SW. The protective switch 28 is coupled to an output end of the battery unit 21 or a route where the output current I_{O1} flows for protecting the battery module BM1. When there is an over current or an over voltage, the protective switch 28 cuts off to prevent the battery module BM1 or the system end from being damaged.

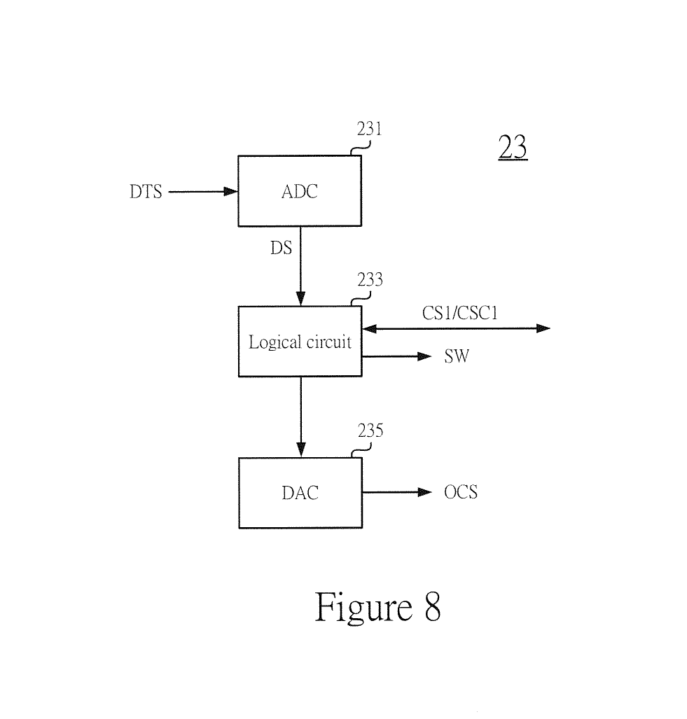

Referring to FIG. 8, a block diagram of the circuit of the control unit of a preferred embodiment of the present invention is shown. As shown in the figure, the control unit 23 includes an analog to digital converter (ADC) 231, a logical circuit 233 and a digital to analog converter (DAC) 235. The analog to digital converter 231 is coupled to the current detecting unit 22 for converting the detecting signal DTS into a digital signal DS and then outputting it to the logical circuit 233. The logical circuit 233 is coupled to the analog to digital converter 231 for determining if the current quantity of the output circuit I_{O1} is higher or lower than the threshold value according to the digital signal DS and then outputting the current status signal CS1 correspondingly. The digital to analog converter 235 is coupled to the logical circuit 233 to receive the current sharing control instruction CSC1 sent back by the main controller MC via the logical circuit 233 and then convert the current sharing control instruction CSC1 into the on-state control signal OCS for outputting.

Wherein, if the control unit 23 needs to output the switching signal SW to control the switch unit 25, the logical circuit 233 can output the switching signal SW to the switch unit 25 directly.

To sum up, the power supply with current sharing control and its battery modules in accordance with the present invention are disclosed. Wherein, the power supply comprises a main controller and a plurality of parallel-connected battery modules. The battery modules output a plurality of current status signals according to current quantities of the output currents output by respective battery units themselves. The main controller outputs a plurality of current sharing control instructions according to the current status signals, thereby commanding the battery modules to adjust the output current quantities of the output currents. Accordingly, the battery modules of the present invention self-adjust the output currents of the respective battery units to equalize the current quantities of the output currents of the battery units, thereby promoting the supplying efficiency of the power supply and preventing the battery units from being damaged due to a forced discharge.

What is claimed is:

1. A power supply with current sharing control comprising:
a plurality of battery modules, said battery modules being connected in parallel and outputting a plurality of output currents respectively, said battery modules outputting a plurality of current status signals according to respective current quantities of said output currents; and
a main controller coupled to said battery modules and outputting a plurality of current sharing control instructions to said battery modules respectively according to said current status signals;
wherein said battery modules adjust said output current quantities of said output currents according to said current sharing control instructions respectively.

2. The power supply as claimed in claim 1 further comprising:
a busway for coupling said main controller to said battery modules.

3. The power supply as claimed in claim 1, wherein said battery modules respectively include:
a battery unit for providing said output current;
a current detecting unit coupled to said battery unit and detecting said current quantity of said output current to output a detecting signal;
a control unit coupled to said current detecting unit and outputting said current status signal according to said detecting signal, said main controller sending said current sharing control instruction back to said control unit according to said current status signal, whereby said control unit outputs an on-state control signal according to said current sharing control instruction; and
a first switch unit coupled to said battery unit and said control unit, a conduction degree of said first switch unit being determined according to said on-state control signal, and said current quantity of said output current which flows through said first switch unit being decided by said conduction degree.

4. The power supply as claimed in claim 3, wherein when said current quantity of said output current output by said battery unit is higher than a threshold value, said control unit uses said on-state control signal to control said conduction degree of said first switch unit to a smaller state; when said current quantity of said output current output by said battery unit is lower than a threshold value, said control unit uses said on-state control signal to control said conduction degree of said first switch unit to a larger state.

5. The power supply as claimed in claim 3, wherein said control unit includes:
an analog to digital converter coupled to said current detecting unit and converting said detecting signal into a digital signal for outputting;
a logical circuit coupled to said analog to digital converter, determining if said current quantity of said output circuit is higher or lower than a threshold value according to said digital signal and then outputting said current status signal correspondingly; and
a digital to analog converter coupled to said main controller and converting said current sharing control instruction into said on-state control signal for outputting.

6. The power supply as claimed in claim 5, wherein said first switch unit is a power transistor, a gate electrode of said power transistor being coupled to said digital to analog converter, said output current flowing through a drain electrode and a source electrode of said power transistor, said gate electrode of said power transistor receiving said on-state control signal for operating in a linear region according to said on-state control signal, thereby controlling said conduction degree between said drain electrode and said source electrode of said power transistor.

7. The power supply as claimed in claim 3, wherein said battery module further includes:
a second switch unit coupled to said battery unit and said control unit and controlled by said control unit to conduct or cut off said output current.

8. A battery module of a power supply with current sharing control comprising:
a battery unit for providing an output current;
a current detecting unit coupled to said battery unit and detecting a current quantity of said output current for outputting a detecting signal;
a control unit coupled to said current detecting unit and outputting a current status signal to a main controller according to said detecting signal, said main controller sending a current sharing control instruction back to said control unit according to said current status signal, whereby said control unit outputs an on-state control signal; and
a first switch unit coupled to said battery unit and said control unit, a conduction degree of said first switch unit being determined according to said on-state control signal, and said current quantity of said output current which flows through said first switch unit being decided by said conduction degree.

9. A power supplying method for current sharing control comprising steps of:
connecting a plurality of battery modules in parallel and outputting a plurality of output currents respectively;
outputting a plurality of current status signals according to current quantities of said output currents respectively;
coupling a main controller to said battery modules and outputting a plurality of current sharing control instructions to said battery modules respectively according to said current status signals; and
adjusting said output current quantities of said output currents according to said current sharing control instructions respectively.

10. The power supplying method as claimed in claim 9, wherein said battery module detects said output current quantity of said output current and determine if said current quantity of said output current is higher or lower than a threshold value, thereby outputting said current status signal correspondingly.

11. The power supplying method as claimed in claim 10, wherein when said battery module determines that said current quantity of said output current is higher than said threshold value, said main controller sends said current sharing control instruction back according to said current status signal output by said battery module to allow said battery module to decrease said current quantity of said output current.

12. The power supplying method as claimed in claim 10, when said battery module determines that said current quantity of said output current is lower than said threshold value, said main controller sends said current sharing control instruction back according to said current status signal output by said battery module to allow said battery module to increase said current quantity of said output current.

13. The power supplying method as claimed in claim 10, wherein said main controller outputs said current sharing control instructions to said battery modules for commanding said battery modules to adjust said current quantities of said output currents to said threshold value.
